(19) United States
(12) Patent Application Publication
(10) Pub. No.: US 2002/0134440 A1
(43) Pub. Date: Sep. 26, 2002

(54) Pressurized fluid tank reserve system

(76) Inventor: Tony Mandzuk, North Vancouver (CA)

Correspondence Address: NORMAN M. CAMERON, SUITE 1401 - 1166 ALBERNI STREET, VANCOUVER, BC, V6E 3Z3, CA

(21) Appl. No.: 09/811,548

(22) Filed: Mar. 20, 2001

(51) Int. Cl. G05D 7/00

(52) U.S. Cl. 137/590; 137/571

(57) ABSTRACT

A storage device for a pressurized fluid includes a main container having an exterior. A reserve container is within the main container. A first valve is operatively connected to the reserve container. The first valve is a one-way valve. The first valve admits pressurized fluid from the main container to the reserve container and prevents fluid from flowing through the valve from the reserve container to the main container. A second valve is operatively connected to the reserve container. The second valve has an actuator accessible from the exterior of the main container for opening the second valve to discharge pressurized fluid from the reserve container to the main container.

### BACKGROUND OF THE INVENTION

This invention relates to pressurized fluid storage devices and, in particular to propane tanks having reserve reservoirs.

Propane-powered vehicles, such as forklifts, sometimes run out of fuel at an inconvenient location. If this occurs, then it is necessary to tow the vehicle back to a fuelling location or transport a quantity of fuel to the vehicle. These problems could be alleviated if the vehicle had a reserve storage tank to provide enough fuel to power the vehicle back to a fuelling location.

Various systems have been developed to provide a reserve reservoir for fuel tanks of one type or another. For example, U.S. Pat. No. 5,046,945 to McGowan shows a reserve flammable gas container apparatus. There are two separate containers.

U.S. Pat. No. 3,710,809 to Brown et al. shows a reserve fuel system for forklifts. A separate reserve tank is employed.

U.S. Pat. No. 5,975,574 to Warth shows the use of a separate auxiliary tank.

U.S. Pat. No. 5,704,387 to Sims shows another propane reserve system. The primary fuel tank provides fuel both to the engine and a reserve tank.

European Patent App. No. 90907679.6 has a reserve container located in a main tank. There is a pressure-responsive reserve valve which delivers fuel from the reserve container to a pump at fuel levels below a predetermined fuel level.

The prior art does not reveal a system well adapted for providing a reserve fuel supply for propane-powered vehicles or other propane-fuel devices such as barbecues. In particular the prior art does not reveal a system which is capable of fitting existing units, particularly standard propane tanks.

It is therefore an object of the invention to provide an improved pressurized fluid storage device with a reserve storage capacity for the pressurized fluid.

It is also an object of the invention to provide a pressurized fluid storage device with a reserve gas supply which is compatible with existing attachments for propane tanks.

It is a further object of the invention to provide an improved reserve pressurized fluid storage container which can fit within existing propane storage tanks.

### SUMMARY OF THE INVENTION

There is provided, according to one aspect of the invention, a storage device for a pressurized fluid. The device includes a main container having an exterior. There is a reserve container within the main container. A first valve is operatively connected to the reserve container. The first valve is a one-way valve. The first valve admits pressurized fluid from the main container to the reserve container and prevents fluid from flowing through the valve from the reserve container to the main container. A second valve is operatively connected to the reserve container. The second valve has an actuator accessible from the exterior of the main container for opening the second valve to discharge pressurized fluid from the reserve container to the main container.

There is provided, according to another aspect of the invention, a reserve storage container for a pressurized fluid. The container includes an elongated body having a top and a bottom with a male threaded portion adjacent to the top. A one-way first valve adjacent to the bottom of the body admits pressurized fluid into the body and prevents fluid from flowing through the valve from the body. There is a second valve adjacent to the top of the body having an actuator adjacent to the top of the body which opens the second valve to discharge pressurized fluid from the body.

The invention overcomes deficiencies associated with the prior art. Reserve storage containers according to the invention are simple and compact in structure and can be fitted to existing pressurized fluid storage containers such as propane tanks. Prior art devices are typically more complicated and more difficult to install. Furthermore, many prior art devices are not well adapted for use with pressurized fluids such as propane.

### BRIEF DESCRIPTION OF THE DRAWINGS

In the drawings:

FIG. 1 is a side elevational view, partly broken away, of a storage device for a pressurized fluid according to an embodiment of the invention;

FIG. 2 is an enlarged, fragmentary, top isometric view thereof;

FIG. 3 is an enlarged side elevation, partly in section, of the manual valve and upper part of the reserve container thereof;

FIG. 4 is an is enlarged side elevation, partly in section, of the one- way valve and lower part of the reserve container thereof;

FIG. 5 is a view similar to FIG. 1 of an alternative embodiment having a flexible reserve container; and

FIG. 6 is a view similar to FIG. 1 of another embodiment with a larger reserve container.

### DETAILED DESCRIPTION OF THE PREFERRED EMBODIMENTS

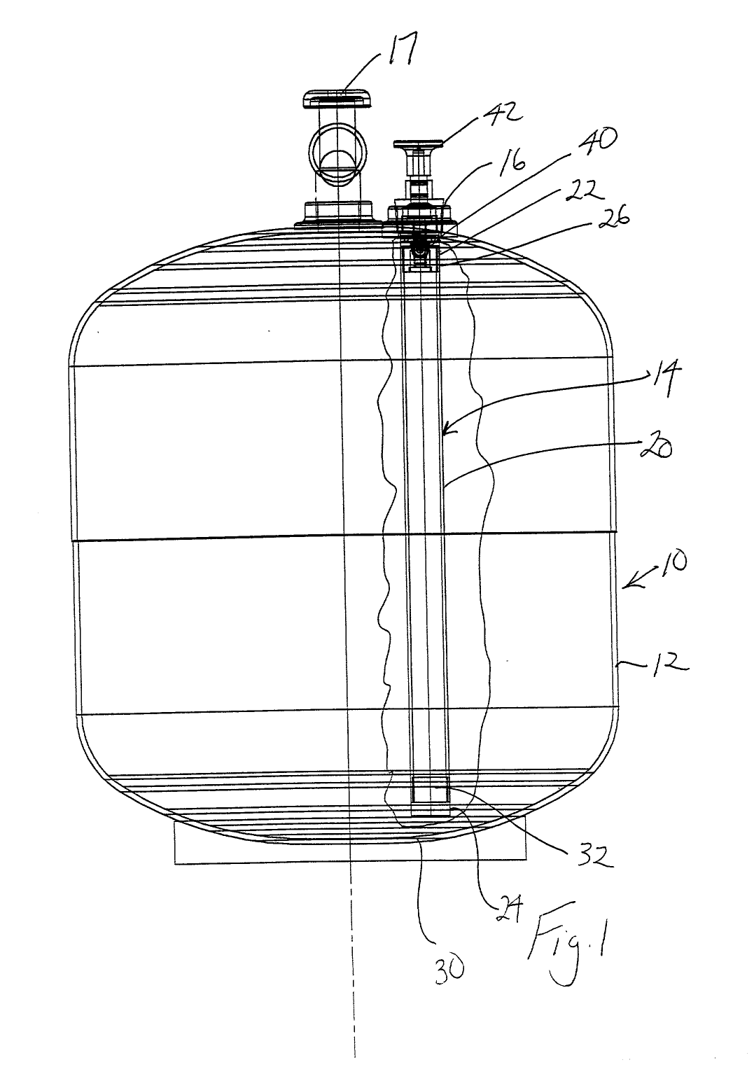

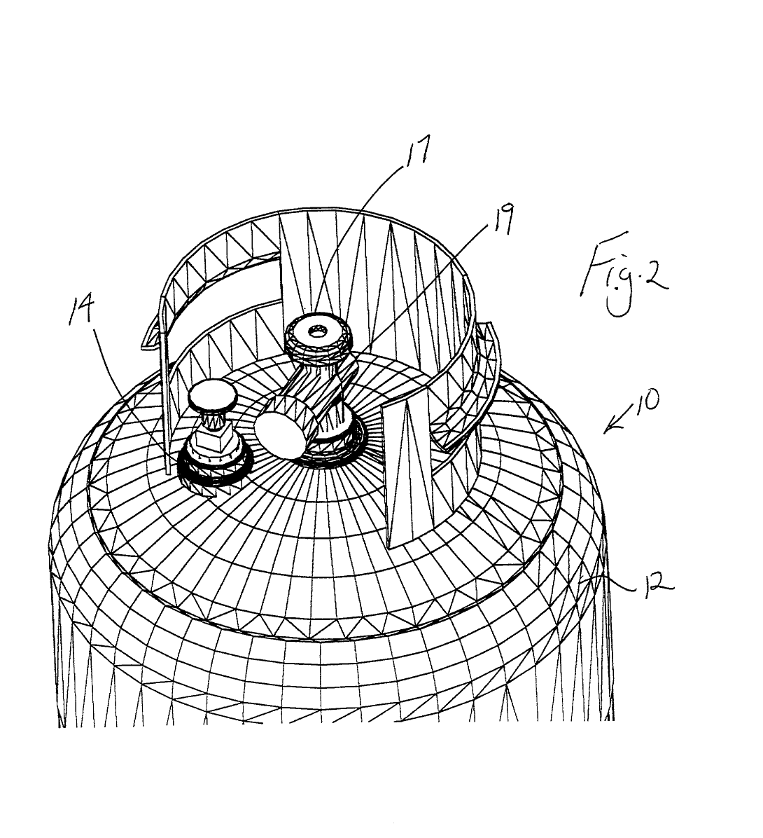

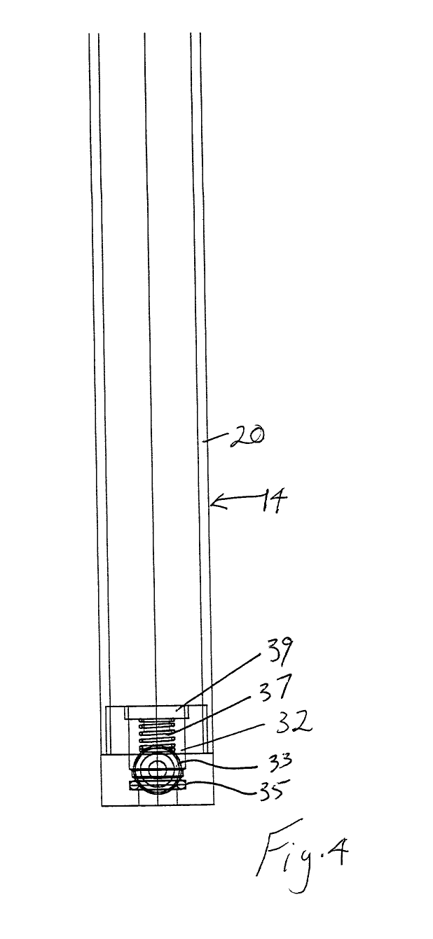

Referring to the drawings, and first to FIG. 1-4, these show a pressurized fluid storage device 10 for a pressurized fluid, propane in this instance. The device includes a main container 12 which in this example is a standard propane tank and accordingly will not be described in more detail. The device includes a reserve container 14 within the main container 12. The main container has a female threaded aperture 16 at the top thereof. This threaded aperture is typically used for installing a manual float gauge. The main container of this example also has a standard valve 17 to control discharge of propane from opening 19.

The reserve container has an elongated, tubular body 20 with a top 22 and a bottom 24. The body in this example is of steel pipe although other materials could be substituted. There is a male threaded portion 26 adjacent to the top of the reserve container. The male threaded portion is configured to threadedly engage corresponding female threads of aperture 16. The container 14 is sufficiently narrow between the threaded portion 26 and the bottom 24 such that the container 14 can fit through the female threaded aperture 16 and extend downwardly through the container 10 until bottom 24 of the reserve container is adjacent to bottom 30 of the container 12. The male threaded portion 26 of the reserve container can then be threaded into the aperture 16 to close the container 12.

The reserve container 14 has a one-way valve 32 operatively connected to the reserve container adjacent to bottom 24 thereof in this particular example. The one-way valve admits pressurized fluid from the main container to the reserve container, but prevents fluid from flowing through the valve from the reserve container to the main container. The valve includes a stainless steel valve 33, in this example, biased against O-ring 35 by coil spring 37 resting against spring retainer 39.

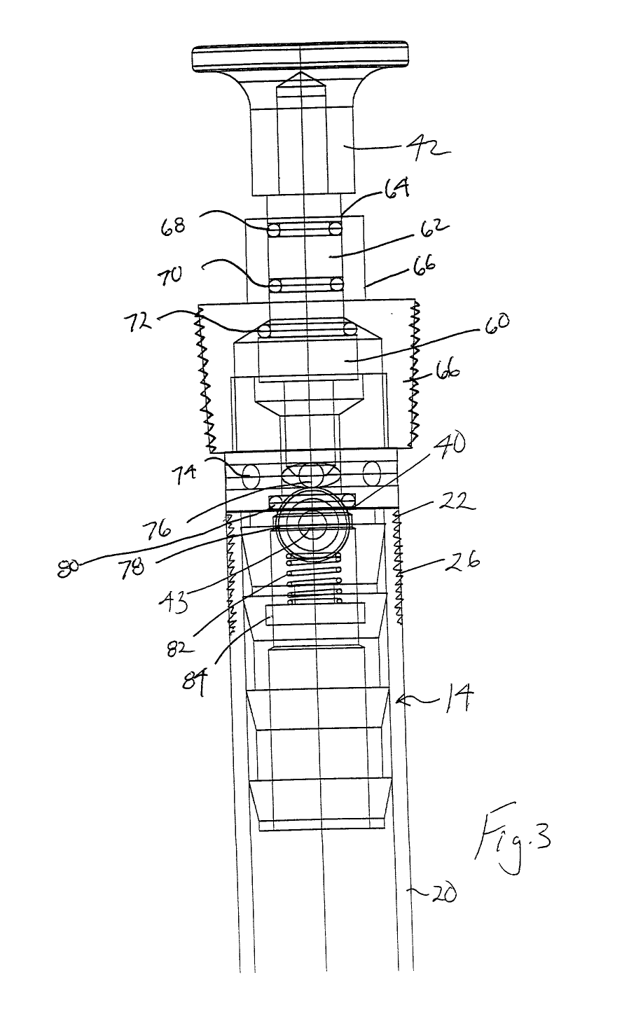

There is a second, manual valve 40 operatively connected to the reserve container adjacent top 22 thereof. There is a button 42 on top of the valve which is accessible from the exterior of container 12. The button serves as an actuator to open valve 40 which permits pressurized fluid within the reserve container 14 to discharge through opening 43 (also referred to herein as a passageway) into the main container 12. As seen in FIG. 3, the button is connected to plunger 60 by stem 62 which extends through bore 64 in body 66. The body has a threaded portion 66 which is received in aperture 16 of the main container. The stem extends through three O-rings 68, 70 and 72 extending about bore 64. The body has a series of vent holes 74. Bottom end 76 of the stem contacts stainless-steel ball 78 which is normally biased against O-ring 80 by coil spring 82 resting on spring retainer 84.

In operation, the tank is filled in a conventional manner through opening 19. As the container 12 fills with pressurized fluid, such as propane, the pressure of the fluid opens one-way valve 32 and enters the interior of reserve container 14. Thus the reserve container is filled when the main container 12 is filled. Valve 40 is normally closed and therefore fluid cannot be discharged through opening 43. When button 42 is pushed, ball 78 is displaced from O-ring 80, allowing gas inside body 20 to discharge through vent holes 74 into the main container.

When the main container 12 is depleted, the operator can push button 42 which opens valve 40 and allows pressurized fluid to discharge from the reserve container 14 into main container 12 through the opening 43. Pressurized fluid can then leave through the opening 19 in the conventional manner and provide enough fuel to operate the propane-powered device for a short time. For example, this gives enough time for an operator to drive a propane-powered vehicle a short distance to a refuelling station. Alternatively it allows a propane-powered barbecue to continue operation for a short time to complete the cooking of food before the tank must be changed.

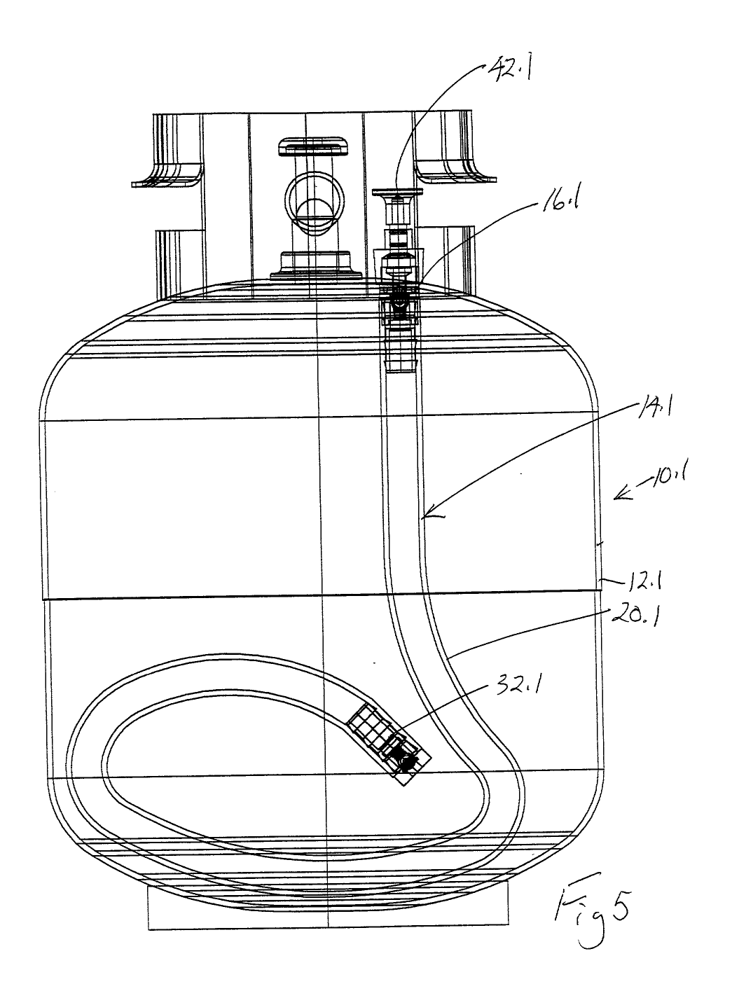

Referring to FIG. 5, the shows and alternative embodiment were like parts have like numbers with the addition of “0.1”. The main difference between this embodiment in the previous one is the nature of the tubular body 20.1 of reserve container 14.1. In this example, rather than having a rigid tubular body, body 20.1 is flexible and hose-like. In this particular example the body is of high-pressure hose made of fiber-reinforced plastic. It may be noted that the body 20.1 is substantially longer than the height of container 12.1 and is coiled inside the main container. This means that the capacity of the reserve container 14.1 is substantially greater than the capacity of reserve container 14 of the previous embodiment as seen by the fact that the reserve container is coiled inside the main container. This modification permits the reserve container to hold considerably more propane compared to the previous embodiment, while still fitting through threaded aperture 16.1.

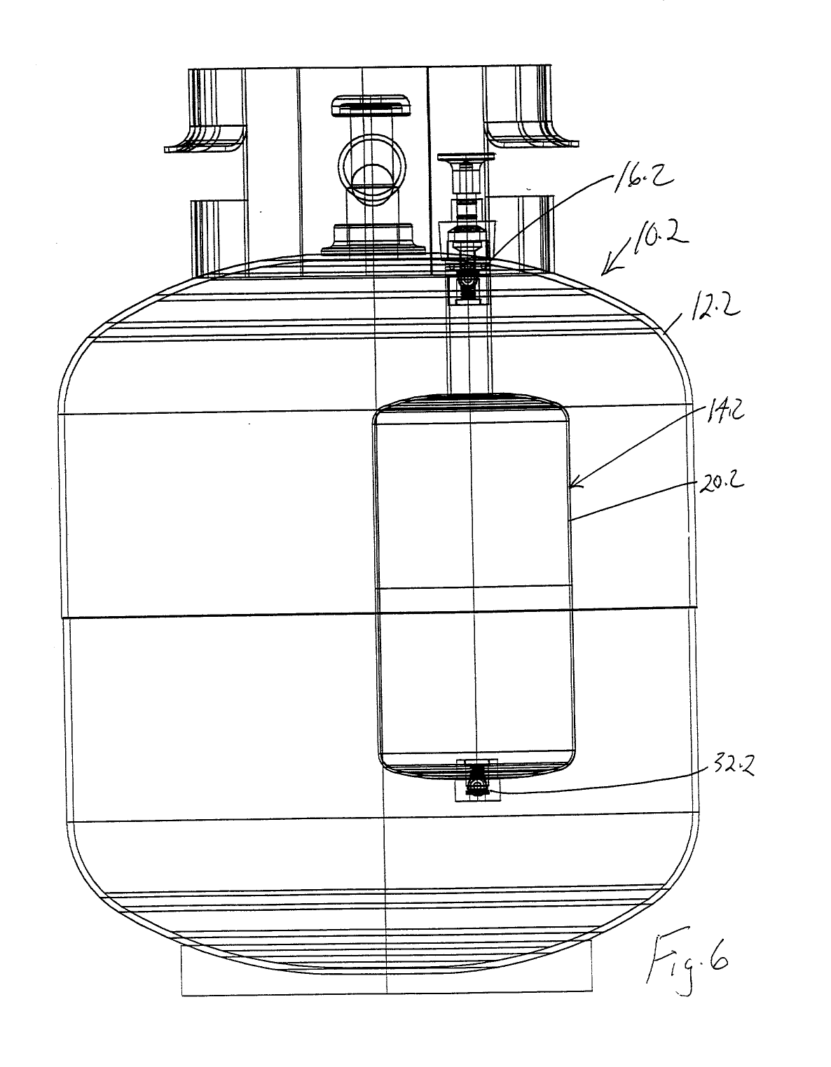

FIG. 6 shows another alternative embodiment of where like arts have like numbers with the addition of “0.2”. In this example the reserve container 14.2 is substantially larger than the reserve container 14, having a substantially larger diameter. However, as may be observed, this reserve container is too large to fit through threaded aperture 16.2. Accordingly it must be located within the main container 12.2 during construction of the main container.

It will be understood by someone skilled in the art that many of the details described above are by way of example only and are not intended to limit the scope of the invention which is to be interpreted with reference to the following claims.

What is claimed is:

1. A storage device for a pressurized fluid, comprising:
a main container having an exterior;
a reserve container within the main container;
a first valve operatively connected to the reserve container, the first valve being a one-way valve, the first valve admitting pressurized fluid from the main container to the reserve container and preventing fluid from flowing through the valve from the reserve container to the main container; and
a second valve operatively connected to the reserve container, the second valve having an actuator accessible from the exterior of the main container for opening the second valve to discharge pressurized fluid from the reserve container to the main container.

2. A device as claimed in claim 1, wherein the first valve is within the main container.

3. A device as claimed in claim 1, wherein the main container is a propane storage tank.

4. A device as claimed in claim 1, wherein the main container has a threaded aperture, the reserve container having a male threaded portion threadedly received in the aperture.

5. A device as claimed in claim 4, wherein the reserve container is tubular.

6. A device as claimed in claim 4, wherein the reserve container has a top and a bottom, the main container has a top and a bottom, the threaded aperture being on the top of the main container and the threaded portion being adjacent to the top of the reserve container.

7. A device as claimed in claim 6, wherein the first valve is adjacent to the bottom of the reserve container.

8. A device as claimed in claim 6, wherein the second valve is adjacent to the top of the main container and the reserve container, the reserve container having a passageway near the top of the reserve container, the second valve normally closing the passageway.

9. A device as claimed in claim 8, wherein the actuator is a button mounted on the top of the main container, the second valve opening the passageway when the button is pushed.

10. A device as claimed in claim 6, wherein the reserve container is dimensioned between the threaded portion and the bottom thereof to fit through the threaded aperture.

11. A device as claimed in claim 5, wherein the main container has a top and a bottom, the reserve container being flexible and longer than a distance between the top and bottom of the main container.

12. A device as claimed in claim 11, wherein the reserve container is dimensioned to fit through the threaded aperture, the reserve container being coiled within the main container.

13. A reserve storage container for a pressurized fluid, comprising:
an elongated body having a top and a bottom with a male threaded portion adjacent to the top thereof;
a one-way first valve of the body which admits pressurized fluid into the body and prevents fluid from flowing through the valve from the body; and
a second valve having an actuator adjacent to the top of the body which opens the second valve to discharge pressurized fluid from the body.

14. A container as claimed in claim 13, wherein the body has a passageway adjacent to the top thereof, the second valve opening the passageway when the actuator is moved.

15. A container as claimed in claim 14, wherein the container is sufficiently narrow between the threaded portion and the bottom thereof so the container can fit through a threaded female opening which threadedly engages the male threaded portion after the container is inserted through the female opening.

16. A container as claimed in claim 14, wherein the container has a male threaded portion and is configured to fit within a propane storage tank with the male threaded portion threadedly engaging a female threaded opening on the propane storage tank.

17. A container as claimed in claim 16, wherein the body is tubular.

18. A container as claimed in claim 13, wherein the first valve is adjacent to the bottom of the body and the second valve is adjacent to the top of the body.

19. A container as claimed in claim 17, wherein the elongated body is flexible.
